(19) United States
(12) Patent Application Publication
(10) Pub. No.: US 2018/0368333 A1
(43) Pub. Date: Dec. 27, 2018

(54) Original Clone Cutter

(71) Applicant: Chad Eric Dorton, Acton, CA (US)

(72) Inventor: Chad Eric Dorton, Acton, CA (US)

(21) Appl. No.: 16/001,906

(22) Filed: Aug. 27, 2018

Related U.S. Application Data
(60) Provisional application No. 62/603,625, filed on Jun. 6, 2017.

(51) Int. Cl. A01G 3/02

(52) U.S. Cl. CPC A01G 3/02

(57) ABSTRACT

The present invention, is a single blade clone cutter. The present inventions embodiment is in a u-shaped housing with a single removal blade. The blade locks in to the u-shaped housing to secure the blade from moving during the process of cutting. It is important to have a single blade that cuts onto a flat surface so there is no damage being done to the fibers at the end of a cutting. It is a new invention because at this point to cut clones it is done free hand with a scalpel or razor blade. The previous procedure to cut clones damages the fibers at the end of a cutting.

### CROSS-REFERENCE TO RELATED APPLICATIONS

This application claims the benefit of provisional patent application Ser. No. 62/600,779, filed 2017 Mar. 2 and Ser. No. 62/603,625 filed 2017 Jun. 6 by the present inventor.

### BACKGROUND—PRIOR ART

The following is a tabulation of some prior art that presently appears relevant:

U.S. Patents

| Pat. No. | Issue Date | Patentee |
|---|---|---|
| 5,438,759 | 1995 Aug. 8 | Janice A. Dieringer |
| US D485,014 S | 2004 Jan. 6 | Dal LaMagna and Mario |
| | | Giampaoli |
| U.S. Pat. No. 8,984,754 B1 | 2015 Mar. 24 | Alexandre Rachid Kaidi |
| | | and Hamid Reza |
| | | Shamsapour |
| U.S. Pat. No. 8,429,825 B2 | 2013 Apr. 13 | James E. Johanson |
| 5,353,505 | 1994 Oct. 11 | Hidekazu Okada |
| 4,902,776 | 1978 Jun. 6 | William Ferguson |
| Des. 273,172 | 1984 Mar. 27 | Masami Yamagishi |
| US D613,571 S | 2010 Apr. 13 | Wolfram Quante |
| 5,016,353 | 1991 May 21 | Clemens A Iten |
| 4,053,979 | 1977 Oct. 18 | Harlan L. Tuthill and |
| | | John O. Freeborn |
| 5,711,075 | 1998 Jan. 27 | Jeffrey A. Wolf |
| U.S. Pat. No. 7,730,620 B1 | 2010 Jun. 8 | Christopher Anastasi |

### BACKGROUND

Clones are cut from Mother Plants. The process for cutting clones today is time consuming and tedious. The process in which clones are cut today rely on using a scalpel or razor blade, both of which are ineffective.

When cutting with a razor blade or scalpel you must set the tool down which exposes the razor blade or scalpel to bacteria. Bacteria in turn can contaminate the clone.

Cutting a clone from a Mother Plant with a razor blade or scalpel you must pinch the top of the new clone and slightly pull up to allow the razor blade or scalpel to cut through the Mother Plant. During this process the cut is not precise.

Another problem with cutting clones with a razor blade or scalpel is if the first cut is done incorrectly, it is very difficult to make a second cut. In order to make a second cut, a clone must be placed on a sanitary cutting board and you must then attempt to push the blade back through.

Clone cutting, is done free-hand. Free-hand cutting is hard on the Mother Plant, her roots and the new clone's stem. The reason it is hard on them is because there is a jerking motion which may cause damage to the Mother Plant and her roots.

Finally, when using a razor blade or scalpel to cut clones there is a risk of injury. If the blade slips it is very easy to cut yourself.

### SUMMARY

Clone cutting is a very time consuming and tedious process which needs to remain sanitary, precise and safe throughout the process. The way clone cutting is done today is not the most effective or efficient process.

### DESCRIPTION OF THE PRIOR ART

U.S. Pat. No. 5,438,759 to Dieringer, is a Button Removal Device. Although the device has the u-shaped housing, it is used to remove buttons from card stock.

U.S. Pat. No. D485,014 S to LaMagna and Giampaoli, is a Cuticle Nipper Tweezer. The Tweezer has the u-shaped housing; however, it is designed to nip cuticles.

U.S. Pat. No. 8,984,754 B1 to Kaidi and Shamsapour, is a Nail Clipper with Blade Insert. The Nail Clipper has the u-shaped housing and removal blade, it is designed to cut finger or toe nails.

U.S. Pat. No. 8,429,825 B2 to Johanson, is a Cutting Apparatus. The Cutting Apparatus has the u-shaped housing with a slot for the blade to push through to an activated position, with the cutting edge extending outwardly of the slot and guide. The Apparatus is used to cut various materials such as paperboard or corrugated paper.

U.S. Pat. No. 5,353,505 to Okada, is Grip Scissors. The Scissors have the u-shaped housing with two blades that slide past each other. The Grip Scissors are used for thread-cutting.

U.S. Pat. No. 4,092,776 to Ferguson, is a Cutting Tool. The Cutting Tool has the u-shaped housing with two blades which are able to crossover and clear said cutting surface.

US. Pat No. Des. 273,172 to Yamagishi, is a Thread Nipper or The Like. The Thread Nipper has the u-shaped housing with two blades that crossover. The purpose of the Thread Nipper is thread-cutting.

U.S. Pat No. D613,571 S to Quante, is a Cutting Implement. The Cutting Implement has the u-shaped housing with two crossover blades.

U.S. Pat. No. 5,016,353 to Iten, is a Suture Cutter. The Suture Cutter has the u-shaped housing with a blade that functions as a probe. It provides a suture cutter for cutting sutures in a skin surface.

U.S. Pat. No. 4,053,979 to Tuthill and Freeborn, is a Suture Cutter. The Suture Cutter has the u-shaped housing and removes surgical sutures with a slicing action.

U.S. Pat. No. 5,711,075 to Wolf, is a Unitarily Formed Plastic Soft Tissue Nipper. The Soft Tissue Nipper has the u-shaped housing with two blades at the end of each arm. The blades are required to be urged into abutting edge-to-edge contact. The purpose of the Soft Tissue Nipper is to be a hand-held tool for removing soft tissue, such as cuticles at base of finger nails.

U.S. Pat. No. 7,730,620 B1 to Anastasi, is a Plastic Package Opener. The Package Opener has the u-shaped housing with a blade member is mounted within the interior surface of an angled leg in order for the blade member to be directed across the surface of a plastic package.

### SUMMARY

The description of prior art all have the u-shaped housing, however serve the purpose of something other than Clone Cutting.

### SUMMARY OF INVENTION

The present invention, The Original Clone Cutter, does not require using a scalpel to cut clones. The embodiment of the invention is a single blade mounted into the u-shaped housing that presses firmly against a flat surface. Only one blade is used, in order to not damage the fibers at the end of a cutting. Cutting clones with the present invention is not hard on the mother plant, her roots or the new clone's stem. The present invention cuts clones without the previous jerking motion caused by using a razor blade or scalpel free hand. There is not a need to pinch and pull up on the new clone stem which is required in prior methods of clone cutting. The present invention allows the blade to remain sanitized which allows for a clean, precise cut. The present invention allows for you to make multiple cuts with the same precision as the first in the circumstance you made your first cut incorrectly. The present invention has an easy squeeze function which allows for easy, safe use in either hand. It allows even the novice clone cutters ease of use.

Clone cutting is important in everyone's every day life. Clone cutting is a huge industry. Having clones remain undamaged during the cutting phase is a huge breakthrough that will benefit the entire world. Cutting clones is important to the world because: almost all fruits and vegetables that are consumed around the world comes from clones. Almost all plants, flowers and trees purchased around the world come from clones. Cloning is also important because most crops are harvested at the same time. In order to produce a crop in which all taste, smell and look the same you must use clones.

### DRAWINGS—FIGURES

FIG. 1 shows the present invention side view and over-head view.

FIG. 2 shows the mounted blade

### DRAWINGS—REFERENCE NUMERALS

3. Single Blade
4. U-Shaped Housing
5. Blade Mounting Block
6. Spacer-Flat Surface
7. Blade Slide Cover
8. Slider Nub
9. Blade Mount

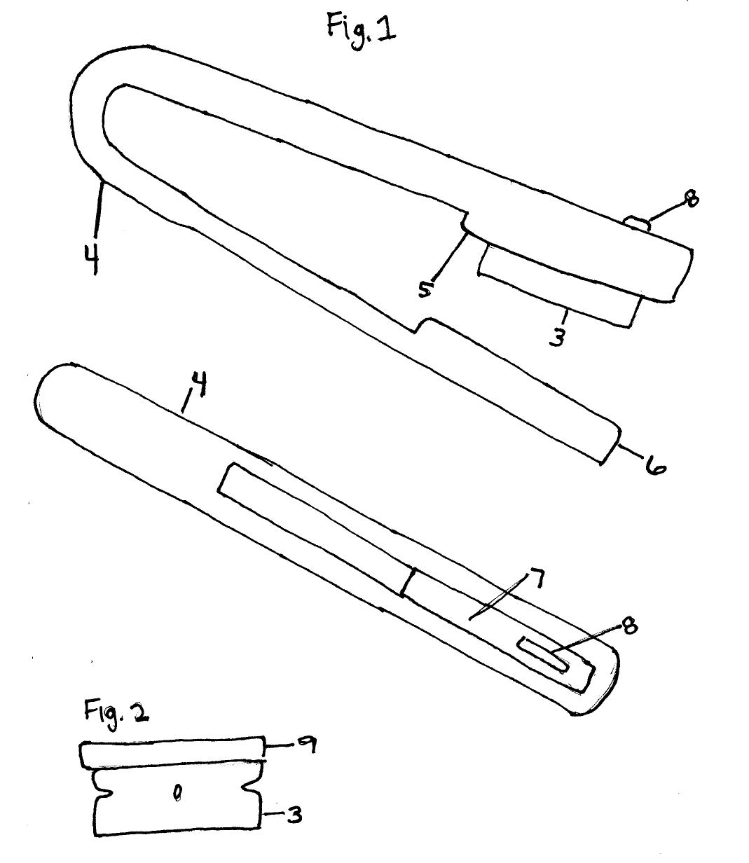

### DETAILED DESCRIPTION—FIG. 1 AND FIG. 2—FIRST EMBODIMENT

In the present invention 4, 5, 6 are all one piece. A Single Blade, 3, is used because a cutting needs to have one clean, precise cut. The Single Blade, 3, is positioned from front to back, to provide the best angle to cut. It is important to only have one blade as having more than one blade to make a cutting, damages the fibers at the end of the cutting. The embodiment of the present invention is the U-Shaped Housing, 4, was made for easy cleaning of the tool, having bacteria get onto to surface of the tool would contaminate the cutting. The U-Shaped Housing, 4, is also used for ease of squeezing the tool with one free hand. The Blade Mounting Block, 5, is used to angle 4, the U-Shaped Housing, to the angle, 3, the Single Blade closes on 6, the Spacer-Flat Surface. The Spacer-Flat Surface, 6, closes at the same angle of the Single Blade, 3. The Blade Slide Cover, 7, keeps the Single Blade, 3, securely in place and slides back and forth for easy removal of the Single Blade 3. 8, The Slider Nub is in place to allow easy control of the Blade Slider Cover, 7. The Blade Mount, 9, fits on the Single Blade, 3, to secure the Single Blade 3, in the Blade Mounting Block, 5.

### Alternative Embodiments

The present invention can have alternative embodiments. Alternative material can be used for the housing. Alternative material that would work for housing would be: fiberglass, plastic, ABS plastic, PVC Plastic, SCH 40 PVC, SCH 80 PVC Plastic, steel, stainless steel, harden steel, spring steel, aluminum or metal.

Alternative blade angles can be used. Alternative angles would be to insert the blade at a 45-degree angle or straight across. However, the blade will work at these angles the best angle is front to back.

I claim:

1. In a clone cutter with a single blade cutting mechanism of the type comprising a u-shaped housing, slider, removeable single blade, and a flat cutting surface for the single blade to cut against.

2. The clone cutter with a single blade cutting mechanism of claim 1 wherein said body is composed of mold injected plastic.

3. The clone cutter with a single blade cutting mechanism of claim 1 wherein said body is a u-shaped housing.

4. The u-shaped housing of claim 3 wherein the top part of the u-shaped housing there is a square dada grove for the single blade to fit into.

5. The u-shaped housing of claim 3 wherein said body has a raised, flat cutting surface beneath the blade.

6. The flat cutting surface of claim 5 wherein said body is raised, the length extends the whole length of the blade and the width of the housing.

7. The clone cutter with a single blade cutting mechanism of claim 1 wherein said body houses a removeable single blade.

8. The single blade of claim 7 wherein said body is a blade with an injection mold encasing the top of the blade.

9. The injection mold of claim 8 wherein the injection mold has a raised notch on one end for the slider to keep blade securely in position.

10. The slider of claim 1 wherein said body is composed of injection mold.

11. The injection mold of claim 10 wherein the body of the slider has a raised button on top of the slider.

12. The slider of claim 10 wherein slides inside a grove in the u-shaped housing directly above the blade.

13. The slider of claim 10 wherein said body has a round indentation underneath the slider which aligns with the notch on the injection mold of the single blade of claim 9.

14. Method of using a clone cutter with single blade cutting mechanism:

15. providing a clone cutter,

16. providing a single blade and inserting the single blade into the clone cutter,

17. pushing closed the slider so the single blade is securely in place,

18. insert mother plant into clone cutter

19. squeeze u-shaped housing closed, bringing the single blade down firmly against the flat cutting surface.
